(19) United States
(12) Patent Application Publication
(10) Pub. No.: US 2010/0161542 A1
(43) Pub. Date: Jun. 24, 2010

(54) DETECTING ENTITY RELEVANCE DUE TO A MULTIPLICITY OF DISTINCT VALUES FOR AN ATTRIBUTE TYPE

(75) Inventor: BARRY M. CACERES, Las Vegas, NV (US)

Correspondence Address: PATTERSON & SHERIDAN, LLP/IBM SVL, 3040 POST OAK BLVD., SUITE 1500, HOUSTON, TX, 77056-6582, US

(73) Assignee: INTERNATIONAL BUSINESS MACHINES CORPORATION, Armonk, NY (US)

(21) Appl. No.: 12/341,579

(22) Filed: Dec. 22, 2008

(51) Int. Cl. G06F 17/00

(52) U.S. Cl. 706/47

(57) ABSTRACT

Techniques are disclosed for providing multiple value detection rules used to determine whether an entity is relevant due to multiple distinct values for an attribute type of the entity in an entity resolution system. Generally, the multiple value detection rules may be applied to attribute types of an entity. When a rule is violated because too many distinct values exist for a particular attribute type, an alert may be generated. Once the alert is generated, additional rules may be applied or skipped. In one embodiment, a rule may be named and given a description.

### BACKGROUND OF THE INVENTION

1. Field of the Invention

Embodiments of the invention generally relate to processing identity records in an entity resolution system, and more particularly, to determining whether an entity is relevant due to multiple distinct values for an attribute type of the entity in an entity resolution system.

2. Description of the Related Art

In an entity resolution system, identity records are received and resolved against known identities to derive a network of entities and relationships between entities. An “entity” generally refers to an organizational unit used to store identity records that are resolved at a “zero-degree relationship.” That is, each identity record associated with a given entity is believed to describe the same person, place, or thing (e.g.: the identity of a employee represented as an employee record from an employee database entity-resolved with the identity of a property owner from the county assessor's public records). Thus, one entity may reference multiple individual identities with potentially different values for various attributes. This is frequently benign, e.g., in a case where an entity includes two identities with different names, a first being an identity record identifying a woman based on a familial surname and a second identity record identifying the same woman based on a married surname. Of course, in other cases, differing attribute values between identities in the same entity may be an indication of mischief or a problem, e.g., in a case where one individual is impersonating another, using a fictitious identity, or engaging in some form of identity theft. The entity resolution system may link entities to one another by relationships. For example, a first entity may have a 1^{st} degree with a second entity based on identity records (in one entity, the other, or both) that indicate the individuals represented by these two entities are married to one another, reside at the same address, or share some other common information.

In entity resolution systems, a single entity may have multiple attribute values for the same attribute type. Frequently, this may result from multiple records being provided that include a value for a given attribute. For example, an entity may have multiple addresses, phone numbers, driver's license numbers, names, etc. In some cases, different values for an attribute may be appropriate (e.g., when a person changes telephone numbers, moves from one place to another or changes a last name after marriage). As described above, multiple attribute values may also indicate a threat, such as fraud.

### SUMMARY OF THE INVENTION

One embodiment of the invention provides a method for processing identity records received by an entity resolution system. The method generally includes selecting an entity in an entity resolution system comprising a plurality of entities. Each entity is associated with a plurality of identity records stored by the entity resolution system. Additionally, each identity record may include one or more attribute types and associated attribute values, and each entity is used to represent a distinct individual. The method may also include evaluating the selected entity using one or more multiple value detection rules. The evaluation may include identifying an attribute type associated with a respective multiple value detection rule, identifying a set of attribute values stored in the identity records of the selected entity that correspond to the identified attribute type, and determining, from the identified set of attribute values, a number of distinct values of the attribute type for the selected entity. The method may also include generating an alert when the number of distinct values exceeds a specified threshold.

Another embodiment of the invention includes a computer program product for processing identity records received by an entity resolution system. The computer program product may include a computer usable medium having computer usable program code. The program code may be configured to select an entity in an entity resolution system comprising a plurality of entities. Each entity may be associated with a plurality of identity records stored by the entity resolution system. Each identity record may include one or more attribute types and associated attribute values, and each entity may be used to represent a distinct individual. The program code may be further configured to evaluate the selected entity using one or more multiple value detection rules. The evaluation may include identifying an attribute type associated with a respective multiple value detection rule, identifying a set of attribute values stored in the identity records of the selected entity that correspond to the identified attribute type, and determining, from the identified set of attribute values, a number of distinct values of the attribute type for the selected entity. The program code may be further configured to generate an alert when the number of distinct values exceeds a specified threshold.

Another embodiment of the invention includes a system having a processor and a memory containing a program, which when executed by the processor, performs an operation for processing identity records received by an entity resolution system. The program may be configured to perform the steps of selecting an entity in an entity resolution system comprising a plurality of entities. Each entity may be associated with a plurality of identity records stored by the entity resolution system. Further, identity record may include one or more attribute types and associated attribute values, and each entity may be used to represent a distinct individual. The program may be configured to evaluate the selected entity using one or more multiple value detection rules. The evaluation may include identifying an attribute type associated with a respective multiple value detection rule, identifying a set of attribute values stored in the identity records of the selected entity that correspond to the identified attribute type, and determining, from the identified set of attribute values, a number of distinct values of the attribute type for the selected entity. The program may be further configured to generate an alert when the number of distinct values exceeds a specified threshold.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a block diagram illustrating a computing environment that includes an entity resolution application and multiple value detection rules, according to one embodiment of the invention.

FIG. 2 is a flow diagram illustrating a method for processing a new identity record in an entity resolution system, according to one embodiment of the invention.

FIG. 3 is a flow diagram illustrating a method for applying multiple value detection rules to an entity in an entity resolution system, according to one embodiment of the invention.

FIG. 4 illustrates an example of graphical user interface components used to configure a multiple value detection rule in an entity resolution system, according to one embodiment of the invention.

FIG. 5 illustrates another example of graphical user interface components used to configure a multiple value detection rule in an entity resolution system, according to one embodiment of the invention.

### DETAILED DESCRIPTION OF THE PREFERRED EMBODIMENTS

An entity resolution system may group identity records into entities using an entity resolution process. A common occurrence within such a system is to have a single entity with multiple values for the same attribute type. For example, an entity may have multiple names, addresses, phone numbers, social security numbers, driver's license numbers, passport numbers, etc. In some cases (e.g.: addresses and phone numbers) it is common for a single entity to have multiple values for an attribute type due to historical attributes accumulated over time or due to the nature of attribute type (e.g., home phone number versus mobile phone number). In other cases, multiple attribute values may indicate potential fraud (e.g., multiple social security numbers).

When a new identity record is received by an entity resolution system, the system may be configured to evaluate the record and associate it with a known entity (or create a new entity). The process of resolving identity records and detecting relationships between entities may be performed using pre-determined or configurable entity resolution rules. Typically, relationships between two entities are derived from information (e.g., a shared address, employer, telephone number, etc.) in identity records that indicate (explicitly or implicitly) a relationship between the two entities. Two examples of such rules include the following:
If the inbound identity record has a matching “Social Security Number” and close “Full Name” to an existing entity, then resolve the new identity to the existing entity.
If the inbound identity record has a matching “Phone Number” to an existing entity, then create a relationship between the entity of the inbound identity record and the one with the matching phone number.
   The first rule adds a new inbound record to an existing entity, where the second creates a relationship between two entities based on the inbound record. Of course, the entity resolution rules may be tailored based on the type of inbound identity records and to suit the needs of a particular case.

One task performed by an entity resolution system is to generate alerts when the existence of a particular identity record (typically the inbound record being processed) causes some condition to be satisfied that is relevant in some way and that may require additional scrutiny by an analyst. For example, the entity resolution system may generate a list of alerts about identities or entities that should be examined by an analyst. In some cases, an alert may be generated if an inbound identity record matches a specific zip code or phone number. In other cases, an alert may be generated if data from an inbound identity record conflicts with entity data. Alerts may be generated to warn that a potential threat or potential fraud may exist. For example, if a person has more than one social security number, then a fraud alert may be generated.

For example, assume that a given individual in an entity resolution system is female. Further assume that records for the individual contain two different values for a “Last Name” attribute. Since it is common for a female individual to change her last name due to marriage, the entity resolution system may not generate a fraud alert. However, if two different last names exist for a male entity, then the potential for fraud is much greater. Therefore, the entity resolution system may generate a fraud alert.

Embodiments of the invention provide multiple value detection rules configured to determine whether an entity is relevant due to multiple distinct values for an attribute type of the entity in an entity resolution system. Generally, the multiple value detection rules may be applied to attribute types of an entity. When a rule is violated because too many distinct values exist for a particular attribute type, an alert may be generated. Once the alert is generated, additional rules may be applied or skipped. In one embodiment, a rule may be named and given a description. A rank may be associated with each rule so that the rules can be ordered for processing. Furthermore, criteria may be applied to a rule in order to specify the type of entities or attributes for which the rule is applied. A detection method may determine whether there are enough distinct values for an attribute type to generate an alert. Method parameters may be required depending on the particular method used to detect the number of distinct values.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable medium may be, for example but not limited to, an electronic, magnetic, optical, electromagnetic, infrared, or semiconductor system, apparatus, device, or propagation medium. More specific examples a computer-readable storage medium include a portable computer diskette, a hard disk, a random access memory (RAM), a read-only memory (ROM), an erasable programmable read-only memory (EPROM or Flash memory), a portable compact disc read-only memory (CD-ROM), an optical storage device, or a magnetic storage device. Further, computer useable media may also include an electrical connection having one or more wires as well as include optical fibers, and transmission media such as those supporting the Internet or an intranet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable storage medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the C programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

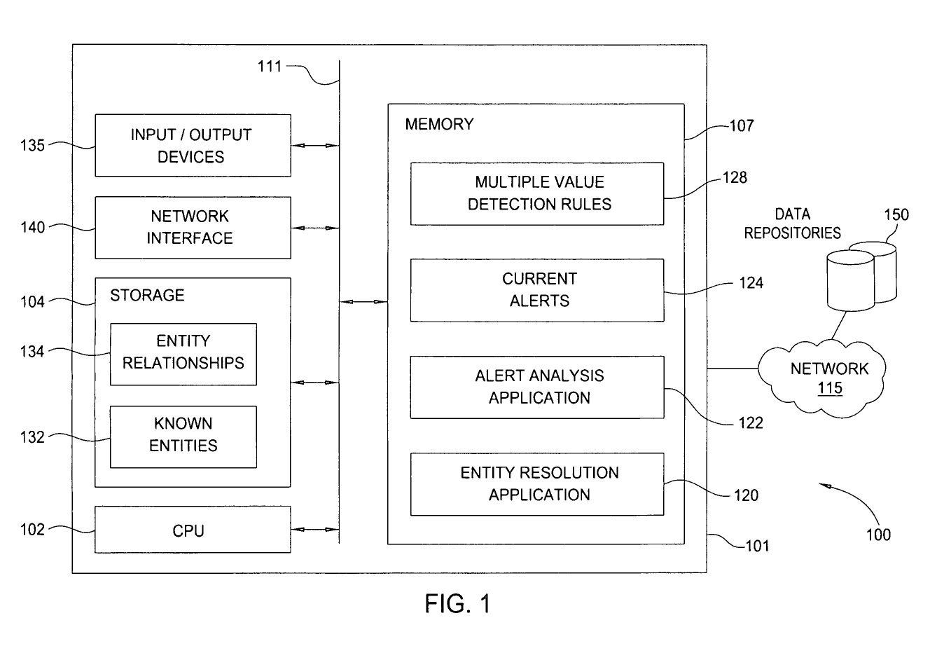

FIG. 1 is a block diagram 100 illustrating a computing environment that includes an entity resolution application 120 and multiple value detection rules 128, according to one embodiment of the invention. A computer system 101 is included to be representative of existing computer systems, e.g., desktop computers, server computers, laptop computers, tablet computers, and the like. However, the computer system 101 illustrated in FIG. 1 is merely an example of a computing system. Embodiments of the present invention may be implemented using other computing systems, regardless of whether the computer systems are complex multi-user computing systems, such as a cluster of individual computers connected by a high-speed network, single-user workstations, or network appliances lacking non-volatile storage. Further, the software applications described herein may be implemented using computer software applications executing on existing computer systems. However, the software applications described herein are not limited to any currently existing computing environment or programming language, and may be adapted to take advantage of new computing systems as they become available.

As shown, computer system 101 includes a central processing unit (CPU) 102, which obtains instructions and data via a bus 111 from memory 107 and storage 104. CPU 102 represents one or more programmable logic devices that perform all the instruction, logic, and mathematical processing in a computer. For example, CPU 102 may represent a single CPU, multiple CPUs, a single CPU having multiple processing cores, and the like. Storage 104 stores application programs and data for use by computer system 101. Storage 104 may be hard-disk drives, flash memory devices, optical media and the like. Computer system 101 may be connected to a data communications network 115 (e.g., a local area network, which itself may be connected to other networks such as the internet). As shown, storage 104 includes a collection of known entities 132 and entity relationships 134. In one embodiment, each known entity 132 stores one or more identity records that are resolved at a “zero-degree relationship.” That is, each identity record in a given known entity 132 is believed to describe the same person, place, or thing represented by that known entity 132. Additionally, computer system 101 includes input/output devices 135 such as a mouse, keyboard and monitor, as well as a network interface 140 used to connect computer system 101 to network 115.

Entity relationships 134 represent identified connections between two (or more) entities. In one embodiment, relationships between entities may be derived from identity records associated with a first and second entity, e.g., records for the first and second entity sharing and address or phone number. Relationships between entities may also be inferred based on identity records in the first and second entity, e.g., records indicating a role of “employee” for a first entity and a role of “vendor” for a second entity. Relationships may also be based on express statements of relationship, e.g., where an identity record associated with the first entity directly states a relationship to the second e.g., an identity record listing the name of a spouse, parent, child, or other family relation, as well as other relationships such as the name of a friend or work supervisor.

Memory 107 can be one or a combination of memory devices, including random access memory, nonvolatile or backup memory, (e.g., programmable or flash memories, read-only memories, etc.). As shown, memory 107 includes an entity resolution application 120 and multiple value detection rules 128. Memory 107 also includes an alert analysis application 122 and a set of current alerts 124. The rules and alerts are discussed in greater detail below.

In one embodiment, the entity resolution application 120 provides a software application configured to resolve inbound identity records received from a set of data repositories 150 against the known entities 132. When an inbound record is determined to reference one (or more) of the known entities 132, the record is then associated with that entity 132. Additionally, the entity resolution application 120 may be configured to create relationships 134 (or strengthen or weaken existing relationships) between known entities 132, based on an inbound identity record. For example, the entity resolution application 120 may merge two entities where a new inbound entity record includes the same social security number as one of the known entities 132, but with a name and address of another known entity 132. In such a case, the new entity would include multiple names believed to represent the same individual.

Further, the entity resolution application 120 (or the alert analysis application 122) may be configured to present a display of records associated with a given entity. For example, assume an alert is generated based on a newly received identity record (e.g., a hotel check-in record that resolves to a male entity, but with different last names). In one embodiment, the entity resolution application 120 (or the alert analysis application 122) may present an alert summary of the attributes of the entity that resulted in such an alert (i.e., the individual using a different last name now believed to be checked-in for a hotel).

Illustratively, computing environment 100 also includes the set of data repositories 150. In one embodiment, the data repositories 150 each provide a source of inbound identity records processed by the entity resolution application 120 and the alert analysis application 122. Examples of data repositories 150 include information from public sources (e.g., telephone directories and/or county assessor records, among others.) The data repositories 150 also include information from private sources, e.g., a list of employees and their roles within an organization, information provided by individuals directly such as forms filled out online or on paper, and records created concomitant with an individual engaging in some transaction (e.g., hotel check-in records or payment card use). Additionally, data repositories 150 may include information purchased from vendors selling data records. Of course, the actual data repositories 150 used by the entity resolution application 120 and the alert analysis application 122 may be tailored to suit the needs of a particular case, and may include any combination of the above data sources listed above, as well as other data sources. Further, information from data repositories 150 may be provided in a “push” manner where identity records are actively sent to the entity resolution application 120 and the alert analysis application 122 as well as in a “pull” manner where the entity resolution application 120 and the alert analysis application 122 actively retrieve and/or search for records from data repositories 150.

In one embodiment, the entity resolution application 120 may be configured to detect relevant identities, entities, conditions, or activities which should be the subject of further analysis. For example, once an inbound identity record is resolved against a given entity, multiple value detection rules 128 may be evaluated to determine whether the entity, with the new identity record, satisfies conditions specified by one or more of the multiple value detection rules. That is, the entity resolution application 120 may determine whether the entity, with the new identity record, has too many values for one or more attribute types. For example, a multiple value detection rule may set a maximum number of values for a “Last Name” attribute to “1” for male entities. Thereafter, when an inbound identity record is resolved against a given male entity, an alert may be generated if there is more than one last name for the entity. The current alerts 124 may be stored in memory 107.

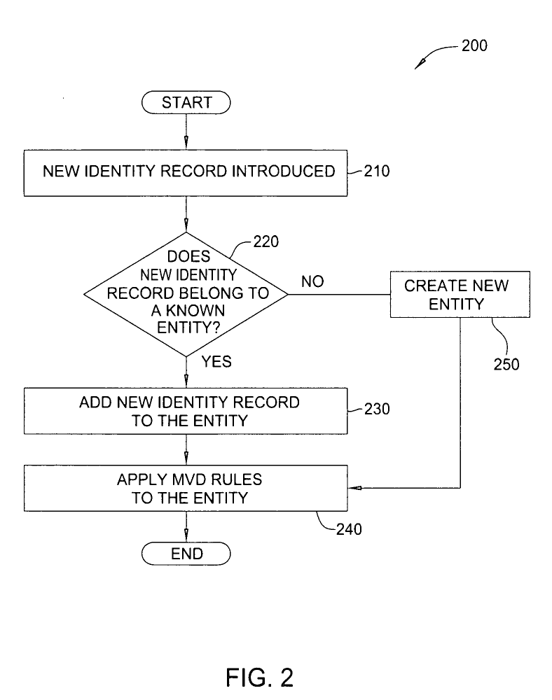

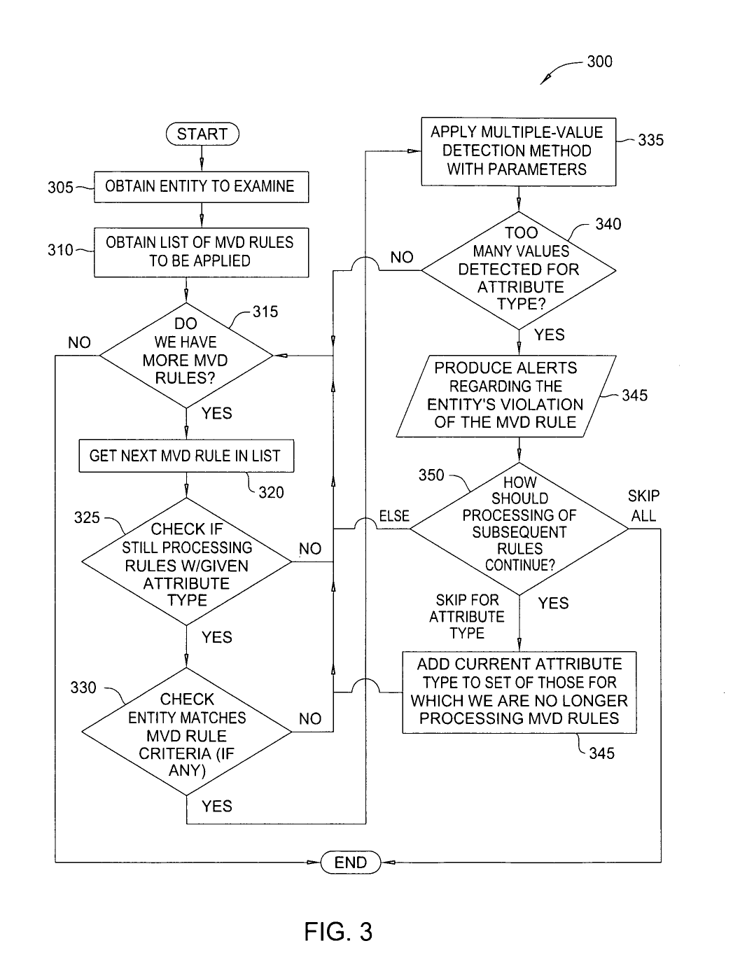

FIG. 2 is a flow diagram illustrating a method 200 for processing a new identity record in an entity resolution system, according to one embodiment of the invention. As shown, the method 200 begins with step 210, where a new identity record is received by the entity resolution application 120. At step 220, the entity resolution application 120 determines if the identity record refers to one of the known entities 132. If so, the identity record is added to that entity. At step 240, the entity resolution application 120 may apply the multiple value detection rules 128 (illustrated in FIG. 3) to the entity. However, if the entity resolution application 120 determines that the identity record does not refer to a known entity at step 220, then a new entity is created (step 250). Once created, the new entity resolution application 120 may apply the multiple value detection rules 128 (illustrated in FIG. 3) to the new entity.

In an alternative embodiment, after step 230, a “re-resolve” process may be performed. The “re-resolve” process determines whether a new larger entity (call it Entity “A”) resulting from the addition of a new identity record to Entity “A” now resolves against any other previously created entities. For example, assume a previous entity (call it entity “B”) includes only a single identity record with a name and phone number. Assume Entity “A” and Entity “B” previously only shared the same name and that this is not a strong enough match to merge the two entities. Further, assume that after performing step 230, Entity “A” and Entity “B” share the same name and phone number because of a new identity record introduced at step 210 included a phone number, name, and social security number. The social security number and name may have been used to resolve the new identity record from step 210 to Entity “A.” But now that Entity “A” has the same name and phone number as Entity “B” and Entity “A” may be merged.

FIG. 3 is a flow diagram illustrating a method 300 for applying multiple value detection rules 128 to an entity in an entity resolution system, according to one embodiment of the invention. As shown, the method 300 begins at step 305, where the entity resolution application 120 selects an entity to evaluate. For example, the entity resolution application 120 may evaluate an entity after a new identity record has been added to that entity or just after the entity has been created (see FIG. 2). Of course, the entity resolution application 120 may evaluate entities in other circumstances. For example, the entity resolution application 120 may evaluate entities on a periodic basis, regardless of how recently new identity records have been added. This may be useful in cases where the identity records have not changed, but new rules have been added, or the threshold for existing rules has changed.

At step 310, the entity resolution application 120 obtains a list of multiple value detection rules 128. A loop then occurs that includes steps 315-355, where one of the multiple value detection rules 128 is applied to values of an attribute type at each pass through the loop until there are no more rules left. At step 315, the entity resolution application 120 may determine if there is another rule. If so, then at step 320, the entity resolution application 120 selects the next rule from the list of rules obtained at step 310. At step 325, the entity resolution application 120 determines whether to continue processing the rule. For example, one might configure two multiple value detection rules 128 to operate on detecting distinct values for the “address” attribute type within an entity. The first rule would use a computationally inexpensive method to determine if the addresses are distinct, but may yield a large number of false negatives, while the second rule uses an algorithm that is computationally relatively more expensive and produces far less false negatives. The method of the first rule might involve only comparing the first 5 digits of the zip codes on the addresses to see if they are the same or different, while the method of the second rule may involve using an address correction/normalization service that determines latitude and longitude and then computes the distance between two addresses. The first rule would be configured to be applied to all entities (no restrictions based on criteria), while the second rule would be configured to only be applied to entities that have already been designated to be of interest (perhaps because the entity has an assigned role within a specific set of roles such as “Known Criminal” or “Watch List”, or perhaps the entity has been assigned a relevance score that is over a specific threshold. If the first rule succeeded in determining that the entity had too many addresses, then there would be no need to run the second rule since it would be redundant; however, if the first rule did not detect too many addresses then we would proceed to step 330 and check if second rule applies to this entity and if so, we would execute the computationally more expensive method of determining distinct addresses against the entity. If the attribute type which the rule applies is no longer being processed (see step 355), then the entity resolution application 120 returns to step 315. However, if the selected rule applies to an attribute type that is available to be processed, the entity resolution application 120 determines if the entity matches the rule criteria, if any (step 330). If not, then the entity resolution application 120 returns to step 315. For example, if the current entity is male, but the current rule only applies to females, then the current entity does not match the rule criteria.

If it is determined that the rule criteria is met, then the entity resolution application 120 applies the rule to the values of the attribute type specified by the rule (step 335). In one embodiment, parameters may be used with the rule. For example, when determining how many distinct values exist for a last name, there may be a parameter specifying how close two names must be in order to be considered the same distinct name (e.g., 85%, 95%, etc.). One of ordinary skill in the art will recognize that many methods exist for determining the similarity of two attribute values (i.e., similarity of two names).

At step 340, the entity resolution application 120 determines whether too many distinct values exist for the current attribute type, according to the rule. If not, then the entity resolution application 120 returns to step 315. However, if there are too many values, then the entity resolution application 120 produces one or more alerts regarding the rule violation (step 345). For example, assume the current rule applies to a “Last Name” attribute type for male entities. Further, assume that the rule is configured so that any male entity with more than one last name generates an alert. If the current entity is male and two distinct last names are found, then the entity resolution application 120 may generate an alert regarding the rule violation. In one embodiment, the alert may display both last names, along with additional entity data (e.g., address, phone number, social security number, etc.).

At step 350, the entity resolution application 120 determines whether to continue processing subsequent attribute types or rules. If the current rule indicates to skip remaining rules (or rules for a particular attribute type) when a rule violation is found, then the entity resolution application 120 does not process any more of the multiple value detection rules 128 (or rules regarding the particular attribute type) and the method terminates. If the current rule indicates that no more rules are to be applied to the current attribute type, then the current attribute type is added to a set of attribute types for which no more rules are being applied (step 355), and the entity resolution application 120 returns to step 315. Otherwise, the entity resolution application 120 simply returns to step 315.

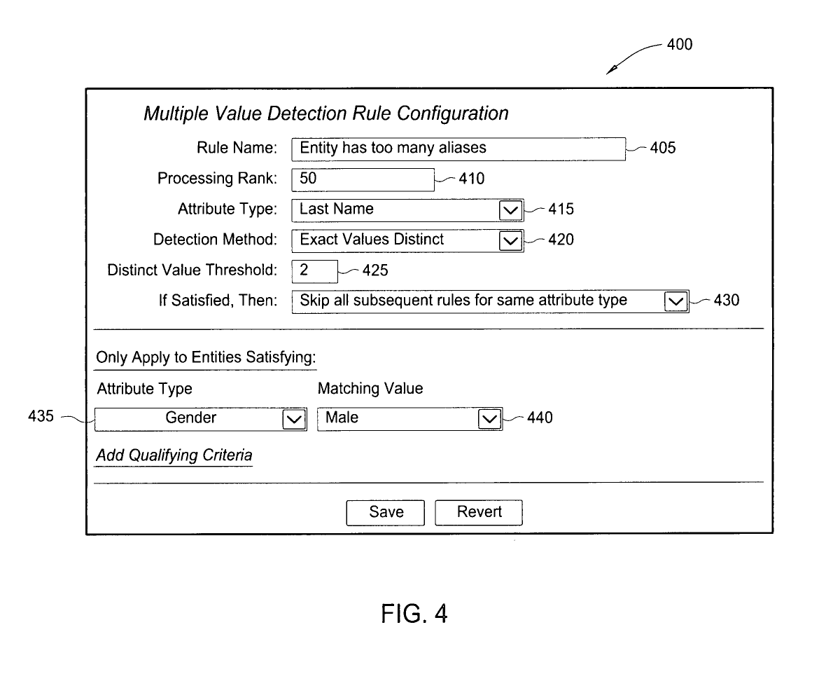

FIG. 4 illustrates an example of graphical user interface components 400 used to configure a multiple value detection rule in an entity resolution system, according to one embodiment of the invention. Illustratively, the interface components 400 are being used to specify a multiple value detection rule for a “Last Name” attribute, as shown in an “Attribute Type” field 415. In this example, the interface components 400 allow a user to enter a name for the rule using a “Rule Name” field 405. As shown, a user has entered a rule name of “Entity has too many aliases.” The “Processing Rank” field 410 allows a user to specify the priority of this rule relative to other rules applied to the “Last Name” attribute type.

The “Detection Method” field 420 allows the user to specify a method used to detect a number of distinct values for the “Last Name” attribute type. As shown, “Exact Values Distinct” is selected. Using the selected method, a last name that differs from another last name by just one letter is considered a distinct value. Of course, one of ordinary skill in the art will recognize that many methods exist for determining the number of distinct values that exist for an attribute. For example, some methods may determine that one or more similar names represent one distinct name (i.e., Michael versus Mike). The user further specifies a value for the “Distinct Value Threshold” field 425. As shown, “2,” is entered into the field 425. Thus, if two or more distinct last names are detected, an alert is generated.

Another field 430 allows a user to specify how to process subsequent multiple value detection rules 128 after an alert is generated. In one embodiment, at least three options are available. A first option is to disregard all subsequent multiple value detection rules 128. A second option is to disregard all subsequent multiple value detection rules for the same attribute type (in this case, “Last Name”). A third option is to not alter the processing of subsequent multiple value detection rules 128.

Illustratively, two additional fields allow the user to configure the rule such that the rule only applies to entities that match a specific value for an attribute type. For example, an “Attribute Type” field 435 allows the user to specify the attribute type and a “Matching Value” field 440 allows the user to specify the specific value required for the rule to be applied to an entity. As shown, the rule is only applied to entities referencing a male individual. In one embodiment, an optional description field may be included for the rule.

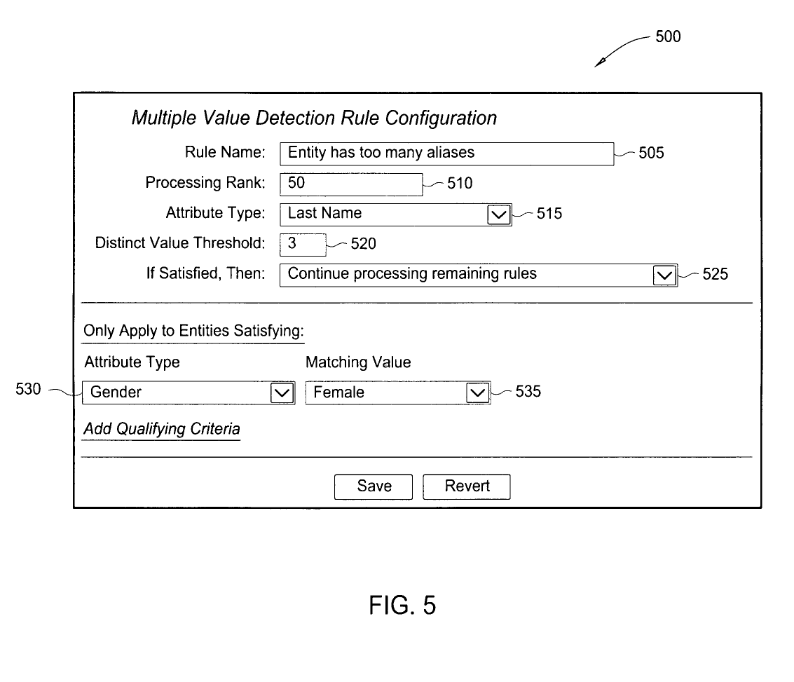

FIG. 5 illustrates another example of graphical user interface components 500 used to configure a multiple value detection rule in an entity resolution system, according to one embodiment of the invention. As shown, the Interface components 500 are similar to the previous interface component 400. However, the rule shown in FIG. 5 is set to only be applied to female entities, as shown in field 535. Therefore, the number of distinct last names allowed before triggering an alert in 520 is higher (“3” for females versus “2” for males). Further, interface 500 shows an example of a rule with only one detection method, so there is no “Detection Method” field, as in interface 400. Also like interface 400, interface 500 includes a “Rule Name” field 505, a “Processing Rank” field 510, an “Attribute Type” field 515, a “Distinct Value Threshold” field 520, an “Attribute Type” field 530, a “Matching Value” field 535, and a field 525 for selecting post-alert options.

Advantageously, as described above, embodiments of the invention provide multiple value detection rules used to determine whether an entity is relevant due to multiple distinct values for an attribute type of the entity in an entity resolution system. The multiple value detection rules may be applied to attribute types of an entity. When a rule is violated because too many distinct values exist for a particular attribute type (as specified by the rule), an alert may be generated. Once the alert is generated, additional rules may be applied or skipped. In one embodiment, a rule may be named and given a description. A rank may be associated with each rule so that the rules can be ordered for processing. Furthermore, criteria may be applied to a rule in order to specify the type of entities or attributes for which the rule is applied. A detection method may determine whether there are enough distinct values for an attribute type to generate an alert. Method parameters may be required depending on the particular method used to detect the number of distinct values. Thus, by applying multiple value detection rules, embodiments of the invention provide an effective method for determining whether the existence of multiple values for an attribute type of an entity is relevant.

While the foregoing is directed to embodiments of the present invention, other and further embodiments of the invention may be devised without departing from the basic scope thereof, and the scope thereof is determined by the claims that follow.

What is claimed is:

1. A computer-implemented method for processing identity records received by an entity resolution system, comprising:
selecting an entity in an entity resolution system comprising a plurality of entities, wherein each entity is associated with a plurality of identity records stored by the entity resolution system, wherein each identity record includes one or more attribute types and associated attribute values, and wherein each entity is used to represent a distinct individual;
evaluating the selected entity using one or more multiple value detection rules, wherein the evaluation using each of the one or more multiple value detection rules comprises:
identifying an attribute type associated with a respective multiple value detection rule,
identifying a set of attribute values stored in the identity records of the selected entity that correspond to the identified attribute type, and
determining, from the identified set of attribute values, a number of distinct values of the attribute type for the selected entity; and
generating an alert when the number of distinct values exceeds a specified threshold.

2. The method of claim 1, further comprising:
receiving a first identity record;
resolving the first identity record to a first entity of the plurality of entities;
adding the first identity record to the first entity; and
evaluating the first entity, as the selected entity, using the one or more multiple value detection rules.

3. The method of claim 1, further comprising:
receiving a first identity record;
generating a new entity;
adding the first identity record to the new entity; and
evaluating the new entity, as the selected entity, using the one or more multiple value detection rules.

4. The method of claim 1, further comprising, generating an entity display summary, wherein the entity display summary includes one or more attribute values of the first entity.

5. The method of claim 1, wherein the multiple value detection rules are applied in an order determined from a ranking value assigned to each respective multiple value detection rule.

6. The method of claim 1, further comprising:
prior to determining the number of distinct values from the identified set of attribute values, determining whether a previous application of one of the multiple value detection rules resulted in the alert being generated for the identified attribute type; and
if so, skipping the evaluation of a current multiple distinct value rule.

7. The method of claim 1, further comprising, in response to determining that the entity is relevant, setting a status flag indicating that subsequent multiple value detection rules for the identifying an attribute type should not be applied to the selected entity.

8. The method of claim 1, wherein one of the multiple value detection rules includes criteria specifying one or more attributes of an entity required for that multiple value detection rule to be applied to a given entity.

9. A computer program product for processing identity records received by an entity resolution system, the computer program product comprising a computer usable medium having computer usable program code configured to:
select an entity in an entity resolution system comprising a plurality of entities, wherein each entity is associated with a plurality of identity records stored by the entity resolution system, wherein each identity record includes one or more attribute types and associated attribute values, and wherein each entity is used to represent a distinct individual;
evaluate the selected entity using one or more multiple value detection rules, wherein the evaluation using each of the one or more multiple value detection rules comprises:
identifying an attribute type associated with a respective multiple value detection rule,
identifying a set of attribute values stored in the identity records of the selected entity that correspond to the identified attribute type, and
determining, from the identified set of attribute values, a number of distinct values of the attribute type for the selected entity; and
generate an alert when the number of distinct values exceeds a specified threshold.

10. The computer program product of claim 9, wherein the computer useable program code is further configured to:
receive a first identity record;
resolve the first identity record to a first entity of the plurality of entities;
add the first identity record to the first entity; and
evaluate the first entity, as the selected entity using the one or more multiple value detection rules.

11. The computer program product of claim 9, wherein the computer useable program code is further configured to:
receive a first identity record;
generate a new entity;
add the first identity record to the new entity; and
evaluate the new entity, as the selected entity, using the one or more multiple value detection rules.

12. The computer program product of claim 9, wherein the computer useable program code is further configured to generate an entity display summary, wherein the entity display summary includes one or more attribute values of the first entity.

13. The computer program product of claim 9, wherein the multiple value detection rules are applied in an order determined from a ranking value assigned to each respective multiple value detection rule.

14. The computer program product of claim 9, wherein the computer useable program code is further configured to:
prior to determining the number of distinct values from the identified set of attribute values, determine whether a previous application of one of the multiple value detection rules resulted in the alert being generated for the identified attribute type; and
if so, skip evaluating a current multiple distinct value rule.

15. The computer program product of claim 9, wherein the computer useable program code is further configured to, in response to determining that the entity is relevant, set a status flag indicating that subsequent multiple value detection rules for the identifying an attribute type should not be applied to the selected entity.

16. The computer program product of claim 9, wherein one of the multiple value detection rules includes criteria specifying one or more attributes of an entity required for that multiple value detection rule to be applied to a given entity.

17. A system, comprising:
a processor; and
a memory containing a program, which when executed by the processor, performs an operation for processing identity records received by an entity resolution system by performing the steps of:
selecting an entity in an entity resolution system comprising a plurality of entities, wherein each entity is associated with a plurality of identity records stored by the entity resolution system, wherein each identity record includes one or more attribute types and associated attribute values, and wherein each entity is used to represent a distinct individual;
evaluating the selected entity using one or more multiple value detection rules, wherein the evaluation using each of the one or more multiple value detection rules comprises:
identifying an attribute type associated with a respective multiple value detection rule,
identifying a set of attribute values stored in the identity records of the selected entity that correspond to the identified attribute type, and
determining, from the identified set of attribute values, a number of distinct values of the attribute type for the selected entity; and
generating an alert when the number of distinct values exceeds a specified threshold.

18. The system of claim 17, wherein the steps further comprise:
receiving a first identity record;
resolving the first identity record to a first entity of the plurality of entities;
adding the first identity record to the first entity; and
evaluating the first entity, as the selected entity using the one or more multiple value detection rules.

19. The system of claim 17, wherein the steps further comprise:
receiving a first identity record;
generating a new entity;
adding the first identity record to the new entity; and
evaluating the new entity, as the selected entity, using the one or more multiple value detection rules.

20. The system of claim 17, wherein the steps further comprise, generating an entity display summary, wherein the entity display summary includes one or more attribute values of the first entity.

21. The system of claim 17, wherein the multiple value detection rules are applied in an order determined from a ranking value assigned to each respective multiple value detection rule.

22. The system of claim 17, wherein the steps further comprise:
prior to determining the number of distinct values from the identified set of attribute values, determining whether a previous application of one of the multiple value detection rules resulted in the alert being generated for the identified attribute type; and
if so, skipping the evaluation of a current multiple distinct value rule.

23. The system of claim 17, wherein the steps further comprise, in response to determining that the entity is relevant, setting a status flag indicating that subsequent multiple value detection rules for the identifying an attribute type should not be applied to the selected entity.

24. The system of claim 17, wherein one of the multiple value detection rules includes criteria specifying one or more attributes of an entity required for that multiple value detection rule to be applied to a given entity.
